(19) United States
(12) Patent Application Publication
(10) Pub. No.: US 2025/0187821 A1
(43) Pub. Date: Jun. 12, 2025

(54) SIDE LOADING ARM FOR A REAR LOADING REFUSE VEHICLE

(71) Applicant: Oshkosh Corporation, Oshkosh, WI (US)

(72) Inventors: Mitchell Murphy, Oshkosh, WI (US); Christopher Lawrence, Oshkosh, WI (US); Andrew Drach, Oshkosh, WI (US); Aaron Jelleberg, Oshkosh, WI (US); Jeremy Bernard, Oshkosh, WI (US); Steve Wagester, Oshkosh, WI (US); Brian Brost, Oshkosh, WI (US); Jill King, Oshkosh, WI (US); Jerrod Kappers, Oshkosh, WI (US); Vince Schad, Oshkosh, WI (US)

(73) Assignee: Oshkosh Corporation, Oshkosh, WI (US)

(21) Appl. No.: 18/970,326

(22) Filed: Dec. 5, 2024

Related U.S. Application Data
(60) Provisional application No. 63/606,652, filed on Dec. 6, 2023.

(51) Int. Cl. B65F 3/04; B65F 3/02

(52) U.S. Cl. CPC B65F 3/041; B65F 2003/023; B65F 2003/0276

(57) ABSTRACT

A refuse vehicle includes a chassis, a body assembly, a tailgate assembly, and a lift system. The body assembly is coupled to the chassis and defines a primary refuse compartment. The tailgate assembly is rotatably coupled to the body assembly at a rear end of the refuse vehicle. The lift system is coupled to the tailgate assembly and includes a side-loading arm and an actuation mechanism. The side-loading arm is configured to engage a refuse container and move between a plurality of positions laterally away from the tailgate assembly. The actuation mechanism is configured to control movement of the side-loading arm.

### CROSS-REFERENCE TO RELATED APPLICATIONS

This application claims the benefit of and priority to U.S. Patent Application No. 63/606,652, filed Dec. 6, 2023, the entire contents of which are hereby incorporated by reference herein.

### BACKGROUND

Refuse vehicles collect a wide variety of waste, trash, and other material from residences and businesses. Operators of the refuse vehicles transport the material from various waste receptacles within a municipality to a storage or processing facility (e.g., a landfill, an incineration facility, a recycling facility, etc.).

### SUMMARY

One embodiment of the present disclosure relates to a refuse vehicle including: a chassis; a body assembly coupled to the chassis and at least partially defining a primary refuse compartment; a tailgate assembly rotatably coupled to the body assembly at a rear end of the refuse vehicle; a lift system coupled to the tailgate assembly. The lift system includes: a side-loading arm configured to engage a refuse container and move between a plurality of positions laterally away from the tailgate assembly; and an actuation mechanism configured to control movement of the side-loading arm.

Another embodiment of the present disclosure relates to a lift system for a rear loading refuse vehicle. The lift system includes: a support configured to mount the lift system to a tailgate assembly of a rear-loading refuse vehicle; a side-loading arm coupled to the support and configured to move between a plurality of positions; a refuse container engagement mechanism coupled to the side-loading arm and configured to grasp and release a refuse container; and an actuation mechanism coupled to the side-loading arm and the refuse container engagement mechanism. The actuation mechanism includes at least one actuator configured to selectively extend the side-loading arm in a direction laterally outwards from the support between a retracted position and an extended position; and at least one actuator configured to selectively actuate the refuse container engagement mechanism between an open position and a grasping position.

Still another embodiment of the present disclosure relates to a method for operating a lift system of a rear loading refuse vehicle. The method includes: activating an actuation mechanism to reposition a side-loading arm of the refuse vehicle laterally outward from a tailgate assembly of the refuse vehicle; engaging a refuse container using the side-loading arm; and controlling the actuation mechanism to transfer refuse material from the refuse container to a hopper of a refuse vehicle that is defined by the tailgate assembly.

Another embodiment of the present disclosure relates to a refuse vehicle. The refuse vehicle includes a chassis, a body assembly, a tailgate assembly, and a lift system. The body assembly is coupled to the chassis and defines a primary refuse compartment. The tailgate assembly is coupled to the body assembly at a rear end of the refuse vehicle. The lift system is coupled to the tailgate assembly. The lift system includes a side-loading arm, a refuse container engagement mechanism, a motor, and an actuation mechanism. The side-loading arm is configured to engage a refuse container and move between a plurality of positions. The refuse container engagement mechanism is configured to selectively grasp and release the refuse container. The motor is configured to align the refuse container engagement mechanism with the refuse container. The actuation mechanism is configured to receive data and operate the lift system responsive to the received data.

In some embodiments, the actuation mechanism includes at least one actuator configured to operate each of the side-loading arm and the refuse container engagement mechanism. The actuation mechanism further includes at least one sensor and a controller. The at least one sensor is configured to generate sensor data indicative of a position of the refuse vehicle. The controller is communicably coupled to the sensor and is configured to receive the sensor data and operate the actuation mechanism based on the sensor data.

Another embodiment of the present disclosure relates to a lift system. The lift system includes a side-loading arm, a refuse container engagement mechanism, and an actuation mechanism configured to operate the side-loading arm and the refuse container engagement mechanism. The actuation mechanism is configured to selectively extend and actuate the side-loading arm of the lift system between a plurality of positions and operate the refuse container engagement mechanism between an open position and a grasping position. The actuation mechanism further includes a sensor configured to generate sensor data indicative of a position of the refuse container, and a controller configured to receive the sensor data and initiate the actuation mechanism.

Another embodiment of the present disclosure is a method for operating a lift system to collect refuse. Upon arriving proximate to a refuse container, an actuation mechanism is initiated. A controller then obtains sensor data regarding a position of the refuse container. A location of the refuse container is determined based on the sensor data. A refuse container engagement mechanism is aligned with the refuse container based on the location of the refuse container. The refuse engagement mechanism engages the refuse container, and the actuation of the lift system is initiated. Refuse material is transferred from the refuse container to a hopper of a refuse vehicle, and an operator is notified of the completion of the refuse collection.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a rear loading refuse vehicle including a side loading arm, according to an exemplary embodiment.

FIG. 2 is a perspective view of the refuse vehicle of FIG. 1, shown with the side loading arm in an extended position, according to an exemplary embodiment.

FIG. 3 is a perspective view of a rear end of the refuse vehicle of FIG. 1, shown with the side loading arm transitioning between an extended position to a refuse-dumping position, according to an exemplary embodiment.

FIG. 4 is a perspective view of the refuse vehicle of FIG. 1, shown with the side loading arm in the refuse-dumping position, according to an exemplary embodiment.

FIG. 5 is a perspective view of another rear loading refuse vehicle, according to an exemplary embodiment.

FIG. 6 is a perspective view of the refuse vehicle of FIG. 5, shown with a side loading arm of the refuse vehicle in a refuse-dumping position, according to an exemplary embodiment.

FIG. 7 is a perspective view of the refuse vehicle of FIG. 5, shown with an intermediate refuse compartment of the refuse vehicle engaged to transfer refuse material from the intermediate refuse compartment of the refuse vehicle to a primary refuse compartment of the refuse vehicle, according to an exemplary embodiment.

FIG. 8 is a flow diagram depicting a method for detecting and engaging a refuse container by a side arm of a rear loading refuse vehicle, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring to the Figures generally, a refuse vehicle includes a side loading arm at a rear end of the vehicle to lift and manipulate waste receptacles to empty the contents thereof into a hopper volume of the refuse vehicle. The side loading arm operates in response to sensor data retrieved from a refuse can detection system (e.g., a camera, etc.) that is configured to indicate the presence of a refuse container at the location of the side loading arm. The side loading arm may include a grabber device to selectively engage the side loading arm with the refuse container and to dump the contents of the container into the hopper. The side loading arm may be integral with a tailgate assembly of the refuse vehicle, or may be integrated with an intermediate container that is movable relative to the tailgate assembly that can be periodically manipulated to discharge the contents into a tailgate area (e.g., a primary hopper of the rear loading refuse vehicle). Such an arrangement increases the overall efficiency of operation of the refuse vehicle due to the proximity between the rear load hopper and the refuse compartment of the refuse vehicle and because refuse material(s) discharged into the rear load hopper can be moved to the refuse compartment without lifting the refuse container or the intermediate container above the vehicle body.

Additionally, such an arrangement can eliminate the need for a second operator to confirm the presence of the refuse container and/or to facilitate alignment thereof with the side loading arm during operation, which may otherwise be required due to limited visibility of the rear end of the vehicle from where a driver sits within the vehicle. Thus, the system described herein allows for rear end refuse collection without the need for a second operator, providing a solution that is both more efficient and less costly than existing systems.

### Overall Vehicle

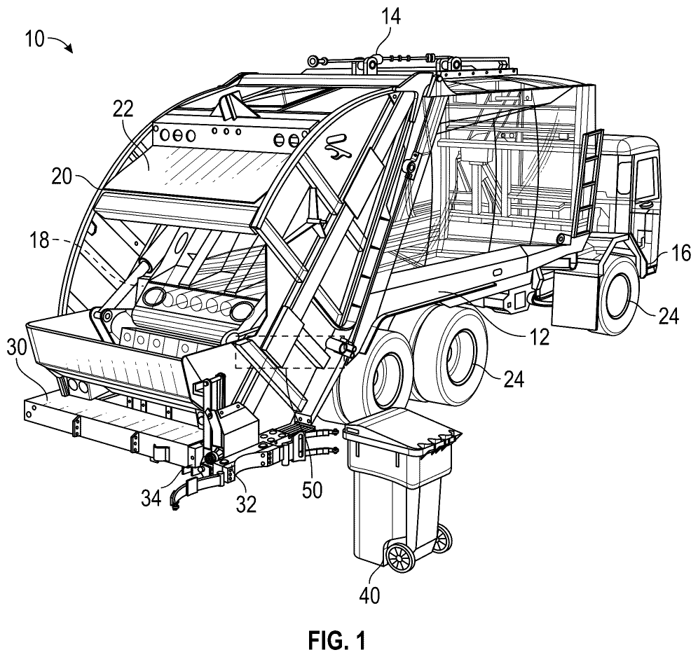

As shown in FIG. 1, a vehicle, shown as refuse vehicle 10, (e.g., a garbage truck, a waste collection truck, a sanitation truck, a recycling truck, etc.) is configured as a rear-loading refuse vehicle. As shown in FIG. 1, the refuse vehicle 10 includes a chassis, shown as a frame 12; a body assembly, shown as body 14, coupled to the frame 12 (e.g., at a rear end thereof, etc.); a tailgate assembly, shown as tailgate 20, coupled to the frame 12 (e.g., at a rear end of the body 14); and a cab, shown as cab 16, coupled to the frame 12 (e.g., at a front end thereof, at an opposite end of the body 14 as the tailgate 20, etc.). The body 14 defines a collection chamber (e.g., hopper, etc.), shown as primary refuse compartment 18. The cab 16 may include various components to facilitate operation of the refuse vehicle 10 by an operator (e.g., a seat, a steering wheel, actuator controls, a user interface, switches, buttons, dials, etc.).

In some embodiments, the refuse vehicle 10 includes a prime mover (e.g., an electric motor, internal combustion engine, etc.) and a power source (e.g., a battery system). According to an exemplary embodiment, the prime mover is coupled to the frame 12 at a position beneath the cab 16. In other exemplary embodiments, the prime mover may be coupled to the frame at a position at least partially within or behind the cab 16.

The prime mover is configured to provide power to a plurality of tractive elements, shown as wheels 24 (e.g., via a drive shaft, axles, etc.). In other embodiments, the prime mover is otherwise positioned and/or the refuse vehicle 10 includes a plurality of prime movers to facilitate independent driving of one or more of the wheels 24. In some embodiments, the prime mover or a secondary prime mover is coupled to and configured to drive a hydraulic system that powers hydraulic actuators. The power source may be coupled to the frame 12 beneath the body 14 or positioned at another location along the refuse vehicle 10 (e.g., within a tailgate of the refuse vehicle 10, beneath the cab 16, along the top of the body 14, within the body 14).

According to an exemplary embodiment, the refuse vehicle 10 is configured to transport refuse from various waste receptacles within a municipality to a storage and/or processing facility (e.g., a landfill, an incineration facility, a recycling facility, etc.). Loose refuse may be placed into the body 14 (e.g., the primary refuse compartment 18) where it may thereafter be compacted (e.g., by a packer system, etc.). The primary refuse compartment 18 may provide temporary storage for refuse during transport to a waste disposal site and/or a recycling facility. According to the embodiment shown in FIG. 1, the body 14 and the primary refuse compartment 18 are positioned behind the cab 16.

The tailgate 20 is rotatably coupled to the body 14 at a first end (e.g., an upper end) of the tailgate 20. In some embodiments, the tailgate 20 is hingedly coupled to the body 14 and is configured to rotate relative to the body 14 to enable access to the refuse compartment 18 such as during unloading events to eject refuse material from the body 14. The tailgate 20 includes a hopper at a rear end of the tailgate 20 that is configured to receive refuse material from a refuse container. The tailgate 20 also includes a hydraulically and/or electrically actuated packer that is configured to move the refuse material from the hopper into the primary refuse compartment 18. In some embodiments, the packer is also configured to compact refuse material within the primary refuse compartment 18 by pushing the refuse material in the longitudinal direction toward a forward wall of the primary refuse compartment 18.

During operation, refuse may be initially loaded into a hopper volume of the hopper and thereafter compacted into the storage volume of the primary refuse compartment 18. In some embodiments, the hopper defines an extended hopper volume that extends in a longitudinal direction (e.g., parallel to frame rails of the frame 12) away from the body 14, rearward of the body 14, which can, advantageously, reduce likelihood of spillage when receiving refuse material from a refuse container. In some embodiments, the hopper extends a distance rearward of the body 14 that is greater than a width of the refuse container so as to enable dumping of the refuse container over a sidewall of the hopper.

As shown in FIG. 1, the refuse vehicle 10 includes a lift mechanism/system (e.g., a side-loading lift system, etc.) shown as lift assembly 30, coupled to the tailgate 20 at the rear end of the body 14. In some embodiments, the lift assembly 30 is coupled to the frame 12 and extends rearward of the tailgate 20. In other embodiments, the lift assembly 30 may be attached directly to the tailgate 20 or to any combination of the tailgate 20, the frame 12, and the body 14. In either arrangement, the lift assembly 30 may include supports that extend in the longitudinal direction away from the tailgate 20. In some embodiments, the supports may include support members that protrude beyond the tailgate 20 and support other portions of the lift assembly 30 proximate to the hopper. The support members may include a pair of beams (e.g., “C” or hat shaped beams defining a rectangular cross-sectional shape, etc.). In some embodiments, the frame 12 defines the support members.

As shown in FIG. 1, the lift assembly 30 is part of a lift system that is configured to engage a container (e.g., a residential trash receptacle, a commercial trash receptacle, a container having a robotic grabber arm, etc.), shown as refuse container 40.

The lift assembly 30 may include various actuators (e.g., electric actuators, hydraulic actuators, pneumatic actuators, etc.) to facilitate engaging the refuse container 40, lifting the refuse container 40, and tipping refuse material out of the refuse container 40 into the hopper from a side of the hopper (e.g., a lateral side of the hopper and refuse vehicle 10). The lift assembly 30 may thereafter return the empty refuse container 40 to the ground. According to an exemplary embodiment, a packer assembly, shown as packer 22, is movably coupled along the tailgate 20 to move refuse material from the hopper into the primary refuse compartment 18 and to at least partially enclose an opening of the tailgate into the primary refuse compartment 18 thereby preventing refuse material from escaping the primary refuse compartment 18 (e.g., due to wind or bumps in the road).

### Automatic Side Loader Arm

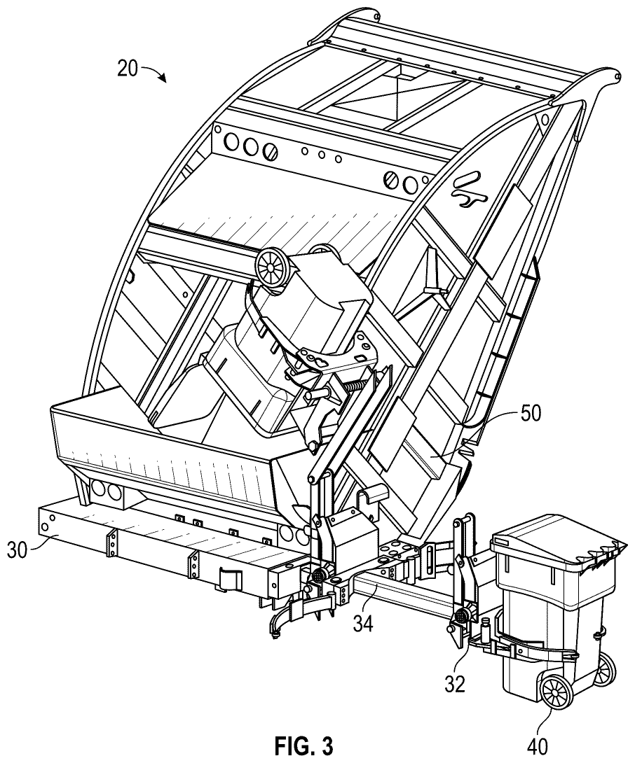

As shown in FIGS. 1-4, the lift assembly 30 of refuse vehicle 10 includes a side-loading arm, shown as reach arm 34. The reach arm 34 is controlled by an actuation mechanism. In some embodiments, the actuation mechanism is an automated actuation mechanism that is at least partially controlled from the cab 16 using a refuse can detection system. For example, the actuation mechanism may be configured to control the reach arm responsive to an indication (e.g., from a sensor) that a refuse container is within a target distance from the reach arm 34 at which actuation will result in engagement between the reach arm 34 and the refuse container. In some embodiments, the actuation mechanism includes a power source that is configured to provide power to the reach arm 34 in response to a control signal from the actuation mechanism. In such embodiments, the reach arm 34 may include an electronic actuator that is configured to power movement of the reach arm 34. In some embodiments, the refuse vehicle may include an electronic power take off that is configured to control the supply of electrical power from the power source to the reach arm 34 and/or other parts of the actuation mechanism. For example, the electronic power take off may include an electronic disconnect and a controller that is configured to power the electronic disconnect to selectively provide electrical power to the reach arm 34 and/or other parts of the actuation mechanism. In still further embodiments, the reach arm 34 may be hydraulically actuated such as by a hydraulic pump onboard the refuse vehicle 10.

According to an exemplary embodiment, the reach arm 34 extends laterally from a side of the lift assembly 30 at the rear end of the body 14. In other exemplary embodiments, the reach arm 34 may include a scissor mechanism, a crane assembly, a telescoping mechanism, etc. to enable operation of the reach arm 34 between a retracted position in which the reach arm 34 is fully retracted toward the hopper and is adjacent the tailgate 20 (e.g., engages a sidewall of the hopper) and an extended position in which the reach arm 34 extends laterally away from the refuse vehicle 10 (e.g., from a side of the refuse vehicle 10) at a greater distance from the refuse vehicle 10 than the retracted position. In some embodiments, the reach arm 34 includes an electric linear actuator (e.g., a linear screw actuator, etc.) that telescopes away from the refuse vehicle 10.

The reach arm 34 is configured to engage the refuse container 40. In some embodiments, the reach arm 34 includes various actuators (e.g., electric actuators, hydraulic actuators, pneumatic actuators, etc.) to facilitate engaging the refuse container 40, lifting the refuse container 40, and tipping the refuse material out of the refuse container 40 into the hopper. The reach arm 34 may thereafter return the empty refuse container 40 to the ground. For example, the lift assembly 30 may include a reever including a winch to facilitate lifting and rotation of the refuse container to discharge refuse material into the hopper. Alternatively, or in combination, the lift assembly 30 may include a kick bar assembly (e.g., a hydraulically actuated kick bar, etc.) to enable rotation and dumping of the refuse container into the hopper.

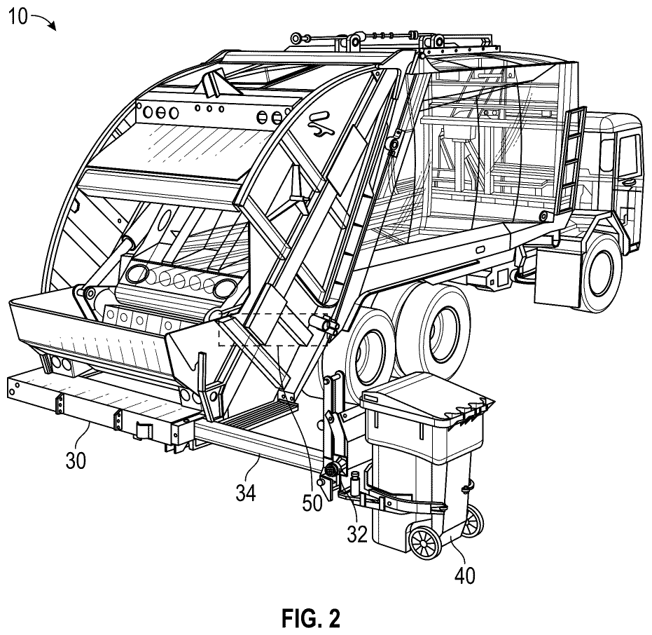

The lift assembly 30 includes a refuse container engagement mechanism, shown as grabber mechanism 32, coupled to a distal end of the reach arm 34. The grabber mechanism 32 is actuatable between an open position (shown in FIG. 1) and a grasping position (shown in FIGS. 2-4). In some embodiments, the grabber mechanism 32 includes a slew motor configured to move the grabber mechanism 32 (e.g., rotationally and/or at least partially laterally) relative to an extension axis of the reach arm 34 (e.g., relative to a lateral direction that is perpendicular to the frame 12) in order to better align the grabber mechanism 32 with the refuse container 40. In some embodiments, the lift assembly 30 does not include the reach arm 34. In such embodiments, the grabber mechanism 32 may rigidly or rotationally coupled to the body 14 (e.g., to the tailgate 20, to the hopper, etc.) or a support member as described above.

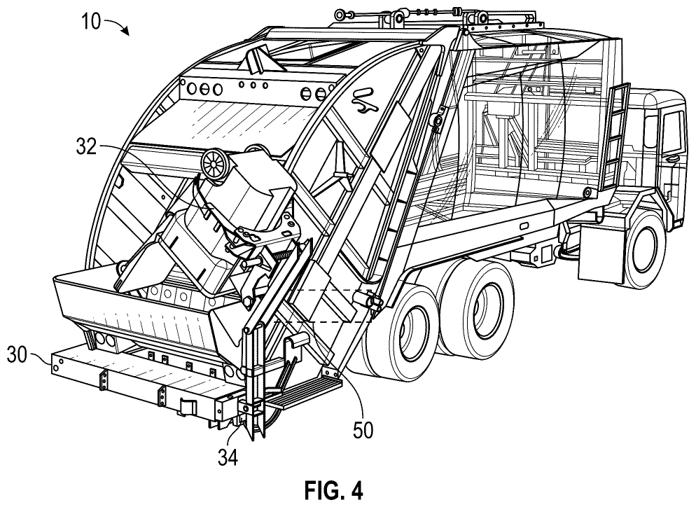

The actuation mechanism is configured to align the grabber mechanism 32 with the refuse container 40 such that the grabber mechanism 32 engages the refuse container 40. Once the grabber mechanism 32 is aligned with and proximate to the refuse container 40, the actuation mechanism may actuate the grabber mechanism 32 from the open position to the grasping position. The actuation mechanism further actuates the reach arm 34 from an extended position (FIG. 2) to a refuse-dumping position (e.g., a retracted position as described above) (FIG. 4) once the refuse container 40 is secured within the grabber mechanism 32.

In some embodiments, the actuation mechanism is configured to receive data from the refuse can detection system for detecting and engaging a refuse container. According to some embodiments, the refuse can detection system may be mounted on or integrated within a refuse vehicle, such as refuse vehicle 10. In some embodiments, the refuse can detection system includes a sensor. The sensor is configured to generate sensor data indicative of a position (e.g., a location, etc.) of the refuse container 40. According to an exemplary embodiment, the sensor may include one or more cameras, shown as camera 50, and/or one or more position sensors (e.g., ultrasonic sensors, optical sensors, etc.) coupled to the exterior of the refuse vehicle 10. The camera 50 may be positioned on the refuse vehicle 10 so that, as the refuse vehicle 10 is driven along a path, the camera 50 captures real-time images adjacent to or in proximity of the path alongside the refuse vehicle 10. For example, the path may be a residential street with garbage cans (e.g., a refuse container 40) placed along the curb. In some embodiments, as shown in FIGS. 1-4, the camera 50 may be coupled to the rear end of the refuse vehicle 10 on the exterior of the tailgate 20. In other embodiments, the camera 50 may be coupled to a curb-side exterior wall of the body 14 of the refuse vehicle 10, to the actuation mechanism, or a combination thereof.

In use, the camera 50 communicates the real-time images to a processor within the refuse can detection system. The real-time images from the camera 50 may be communicated to the processor using additional components such as memory, buffers, data buses, transceivers, etc. The processor is configured to recognize a refuse container (e.g., refuse container 40), based on an image that it receives from the camera 50 and a template representation stored in a database of the refuse can detection system.

The refuse can detection system may include a controller communicably coupled to the camera 50 and configured to control the actuation mechanism. The controller determines the position of the refuse container 40 relative to the tailgate 20 based on the real-time images captured by the camera 50 and initiates actuation of the lift assembly 30 such that the refuse grabber mechanism 32 selectively engages the refuse container 40. The actuation mechanism controls the lift assembly 30 to pick up the refuse container 40 and dump the contents of the refuse container 40 into the hopper on the tailgate 20 of the refuse vehicle 10. When the refuse can detection system detects the refuse container 40, for example along a curb, the actuation mechanism moves the reach arm 34 and the grabber mechanism 32 to engage (e.g., grasp, etc.) the refuse container. For example, the actuation mechanism may be configured to actuate the reach arm 34 and/or grabber mechanism 32 responsive to an indication from the can detection system that the refuse container is within a threshold range of or otherwise satisfies a target can position relative to the reach arm 34, grabber mechanism 32, tailgate 20, and/or body 14.

In some embodiments, the refuse vehicle 10 may also include controls at the tailgate 20 configured to control the lift assembly 30 for manual loading (e.g., by an operator of the refuse vehicle 10). The system may also include other container support features to facilitate engagement and actuation of the refuse container with the actuation mechanism and movement of the refuse container relative to the hopper. In some embodiments, the refuse vehicle 10 also includes at least one rear mounted lift assembly that is coupled to or otherwise disposed along a rear end (e.g., a rear wall) of the hopper to enable collection of refuse from commercial containers from a rear end of the hopper.

It should be appreciated that the actuation mechanism may be modified or otherwise adapted to engage with refuse containers of various shapes and sizes (e.g., residential containers, commercial cans, etc.) and that all such arrangements are contemplated herein.

### Refuse Vehicle With Intermediate Hopper

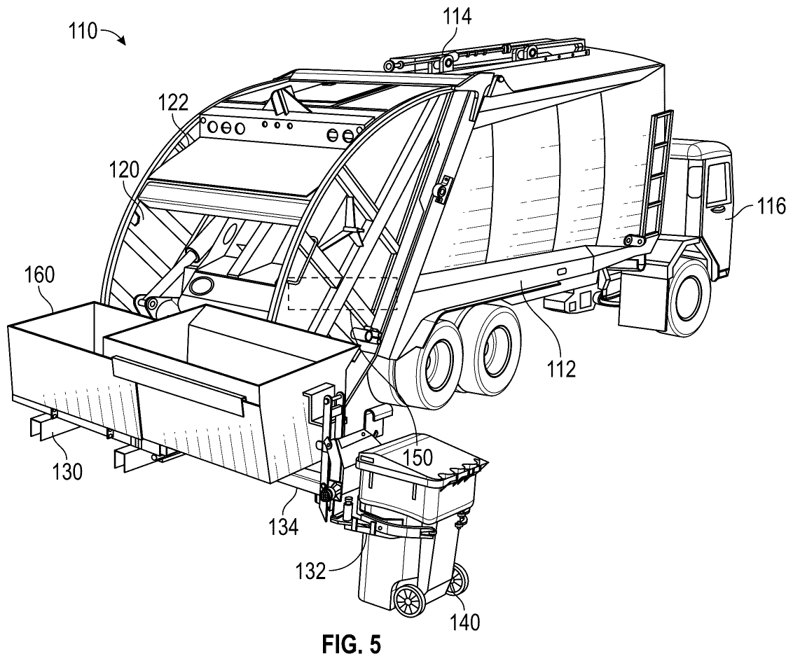

As shown in FIGS. 5-7, a vehicle, shown as refuse vehicle 110 is configured as a rear-loading refuse vehicle. As shown in FIGS. 5-7, the rear-loading refuse vehicle 110 includes a chassis, shown as frame 112; a body assembly, shown as body 114, coupled to the frame 112 (e.g., at a rear end thereof, etc.); a tailgate assembly, shown as tailgate 120, coupled to the frame 112 (e.g., at a rear end of the body 114); and a cab, shown as cab 116, coupled to the frame 112 (e.g., at a front end thereof, at an opposite end of the body 114 as the tailgate 120, etc.). In some embodiments, the refuse vehicle 110 is similar or identical to the refuse vehicle 10. The body 114 includes a collection chamber (e.g., hopper, etc.), defining a primary refuse compartment. The cab 116 may include various components to facilitate operation of the refuse vehicle 110 by an operator (e.g., a seat, a steering wheel, actuator controls, a user interface, switches, buttons, dials, etc.). In some embodiments, the refuse vehicle 110 includes the refuse can detection system of the refuse vehicle 10, shown as camera 150 coupled to refuse vehicle 110.

As shown in FIGS. 5-7, the refuse vehicle 110 includes a lift mechanism/system (e.g., a side-loading lift system, etc.) shown as lift assembly 130, coupled to the tailgate 120 at the rear end of the body 114. The lift assembly 130 is similar or identical to the lift assembly 30 of refuse vehicle 10. In the embodiment of FIGS. 5-7, the refuse vehicle 110 includes an intermediate hopper defining an intermediate hopper volume 160. The intermediate hopper may be removably coupled to the lift assembly 130 and pivotably coupled to the tailgate 120. For example, the intermediate hopper may be coupled to a support member that extends longitudinally away from the tailgate 20 and that also supports the lift assembly 130.

In some embodiments, the intermediate hopper is removable so that the refuse vehicle 110 may be used without the intermediate hopper. The intermediate hopper and/or support system therefor may be retrofit onto an existing refuse vehicle 110, for example, by connecting at least one support member to the refuse vehicle frame and/or body.

In some embodiments, the refuse vehicle 110 includes a tag axle coupled to a frame of the refuse vehicle 110 and configured to improve a load distribution across the refuse vehicle 110. For example, the tag axle may be configured to support an additional weight of the refuse vehicle 110 due to a container and any refuse material contained therein at a rear end of the refuse vehicle 110.

The lift assembly 130 is configured to engage a container (e.g., a residential trash receptacle, a commercial trash receptacle, a container having a robotic grabber arm, etc.), shown as refuse container 140. The lift assembly 130 may include various actuators (e.g., electric actuators, hydraulic actuators, pneumatic actuators, etc.) to facilitate engaging the refuse container 140, lifting the refuse container 140, and tipping refuse material out of the refuse container 140 into the intermediate hopper volume 160. The lift assembly 130 may thereafter return the empty refuse container 140 to the ground. In some embodiments, the lift assembly 130 and/or the intermediate hopper volume 160 may be manually controlled using controls installed at the tailgate 120 of the refuse vehicle 110 (e.g., for use by a second operator) and/or by an automated actuation mechanism as described with reference to FIGS. 1-4.

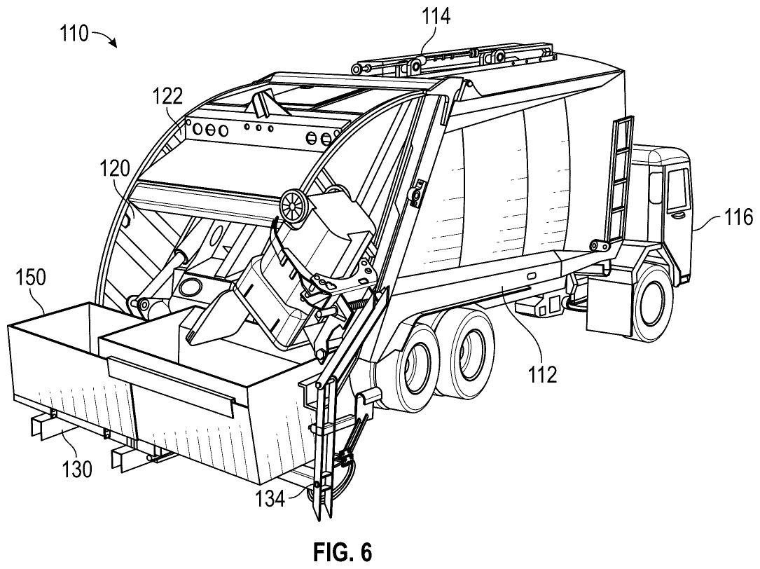

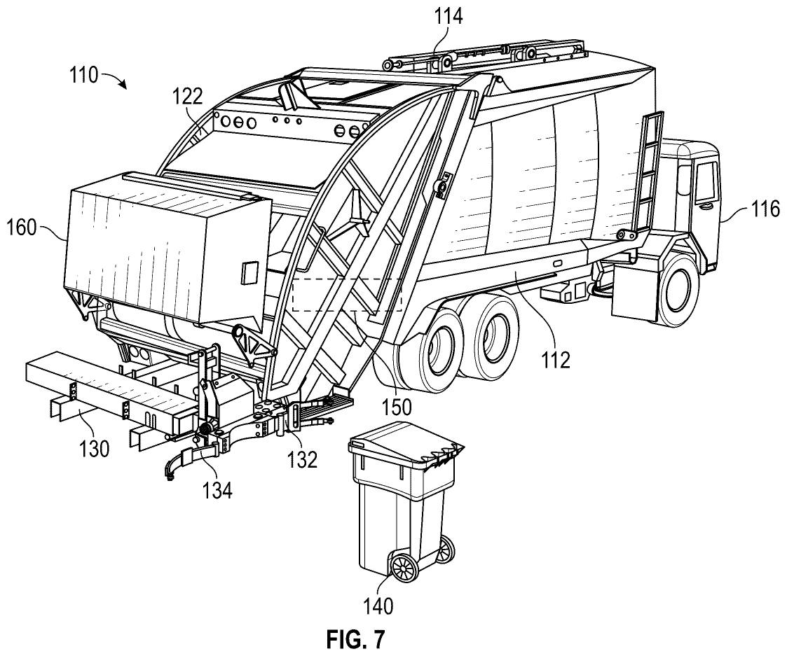

The lift assembly 130 of refuse vehicle 110 may include a side loader arm, shown as reach arm 134, that is similar or identical to the side loader arm of refuse vehicle 10 described with reference to FIGS. 1-4. The reach arm 134 may be controlled by an actuation mechanism similar or identical to the actuation mechanism of refuse vehicle 10. The reach arm 134 is actuatable between an extended position (shown in FIG. 5), a refuse dumping position (shown in FIG. 6), and a retracted position (shown in FIG. 7). The lift assembly 130 includes a refuse container engagement mechanism, shown as grabber mechanism 132, that is similar or identical to the refuse container engagement mechanism described with reference to FIGS. 1-4. The grabber mechanism 132 is disposed at a distal end of the reach arm 134. The grabber mechanism 132 is actuatable between an open position (shown in FIG. 7) and a grasping position (e.g., a closed position to secure the refuse container to the grabber mechanism 132) (shown in FIGS. 5 and 6).

In some embodiments, the lift assembly includes a hopper actuation mechanism that is configured to transfer the refuse material from the intermediate hopper volume 160 into the primary refuse compartment. The actuation mechanism may initiate the transfer of the refuse material upon the lift assembly 130 returning the refuse container 140 to the ground and the reach arm 134 moving to the retracted position, such as when the contents of the intermediate hopper volume 160 exceed or otherwise satisfy a threshold capacity (e.g., a threshold capacity based on a level sensor disposed within or external to the intermediate hopper). In some embodiments, the actuation mechanism is controlled from the automatically based on data from a refuse can detection system. The refuse vehicle 110 may also include standard controls at a tailgate or on the actuation mechanism itself to enable manual actuation of the reach arm, grabber mechanism, and/or intermediate hopper.

In some embodiments, the lift assembly include a reever (e.g., a reever winch system that is mounted to an upper wall of the body 14) including a winch to facilitate lifting and rotation of the intermediate hopper relative to the tailgate to discharge refuse material into a hopper of the tailgate. Alternatively, or in combination, the lift assembly may include a kick bar assembly (e.g., a hydraulically actuated kick bar, etc.) to enable rotation and dumping of the intermediate hopper into the hopper of the tailgate.

As shown in FIGS. 6 and 7, the intermediate hopper may include a movable hopper container that may telescope laterally away from the refuse vehicle 110 and toward the container. For example, the intermediate hopper may be a hopper assembly including a shell and an inner container disposed within an internal volume of the shell. The inner container (e.g., insert, etc.) may be slidably engaged with the shell and may be configured to slide laterally away from the shell during loading (e.g., with the load arm, etc.). In some embodiments, the inner container forms part of the load arm and moves with the grabber assembly relative to the tailgate to engage the container. The intermediate hopper assembly may include an electric actuator (e.g., a linear actuator) and/or a hydraulic actuator to facilitate movement of the inner container relative to the tailgate. Such an arrangement can increase efficiency of loading by enabling loading prior to retraction of the grabber mechanism toward the intermediate container (e.g., by enabling actuation of the inner container while transiting between different garbage pickup locations, while the vehicle is moving between residences, etc.).

As shown in FIG. 7, the intermediate hopper volume 160 rotates upwards about a lateral axis along the rear end of the refuse vehicle 110 extending between two attachment points on the tailgate 120. The intermediate hopper volume 160 is configured to tilt towards the body 114 of the refuse vehicle 110 such that an open top of the intermediate hopper volume 160 faces an opening of the tailgate 120 that is configured to receive the refuse material. According to an exemplary embodiment, a packer assembly, shown as packer 122, is movably coupled along the tailgate 120 to move refuse material from the hopper into the primary refuse compartment and to at least partially enclose an opening of the tailgate 120 into the primary refuse compartment thereby preventing refuse material from escaping the primary refuse compartment (e.g., due to wind or bumps in the road).

### Method for Automating Side Loader Arm

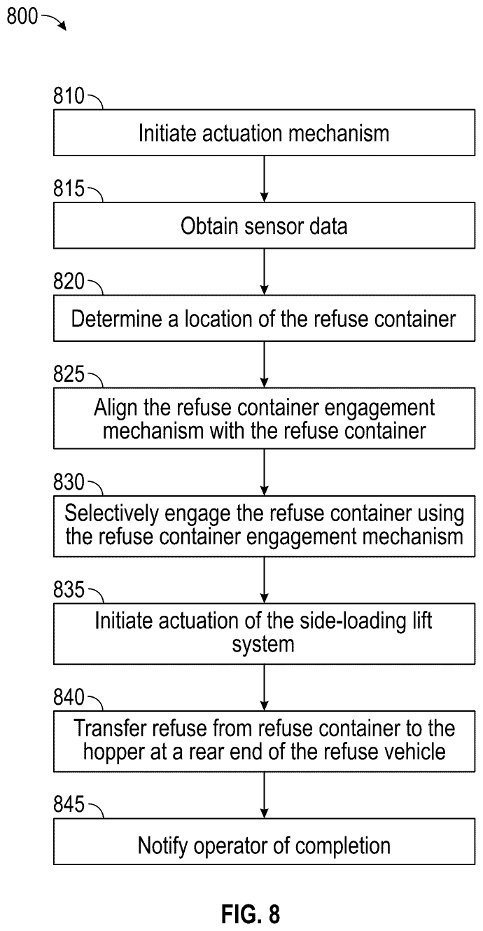

Referring now to FIG. 8, a flow diagram of a method 800 for operating a rear mounted side loader arm system (e.g., detecting and picking up a refuse container from a side of the refuse vehicle into a tailgate hopper defined by the tailgate) is shown, according to an exemplary embodiment. In some embodiments, the method 800 begins when an operator initiates the actuation mechanism, step 810, upon arriving proximate to a refuse container (e.g., refuse container 40, refuse container 140). The operator may initiate (e.g., through an interface, a user device, a control panel, etc.), the actuation mechanism from the cab (e.g., cab 16, cab 116) of the refuse vehicle (e.g., refuse vehicle 10, refuse vehicle 110). In other embodiments, method 800 is initiated based on sensor data received from at least one sensor configured to detect the presence of a container within a threshold distance and/or range of the rear mounted side loader assembly.

At step 815, the method 800 includes obtaining, by a controller of an actuation mechanism and/or refuse can detection system, sensor data from a sensor onboard the refuse vehicle (e.g., camera 50). For example, step 815 may include receiving, by a processor of the controller, real-time images from a camera mounted to the exterior of the refuse vehicle to visually indicate where the refuse container is positioned relative to the tailgate of the refuse vehicle. As another example, step 815 may include retrieving coordinate data from a position sensor mounted to the exterior of the refuse vehicle to detect where the refuse container is in relation to the tailgate and/or rear mounted side loader assembly of the refuse vehicle.

With the data obtained from step 815, the method 800 includes determining a location of the refuse container (step 820). For example, step 820 may include determining a distance between the side of the refuse vehicle and the refuse container. Step 820 may further include determining whether the refuse container is positioned along the same lateral axis of the side-loading arm (e.g., reach arm 34, reach arm 134) or if the refuse container is positioned at an angle away from the side-loading arm (e.g., if a slew motor of a grabber mechanism is required to rotate the grabber mechanism towards the refuse container or otherwise align the grabber mechanism with the refuse container).

At step 825, the method 800 may include aligning the refuse container engagement mechanism with the refuse container based on the location of the refuse container (e.g., responsive to an indication that the refuse container is within a threshold range of the actuation mechanism). For example, responsive to an indication that the refuse container is within a target (e.g., threshold) range (e.g., distance) of the side-loading arm and/or the actuation mechanism, the actuation mechanism may be configured to extend the reach arm laterally the amount of distance between the refuse vehicle and the refuse container (e.g., the distance identified in step 820). When a distal end of the side-loading arm reaches the refuse container, the actuation mechanism may be configured to pause extension of the side-loading arm and may be further configured to activate the refuse container engagement mechanism (e.g., the grabber mechanism).

The method 800 may further include, upon aligning the refuse container engagement mechanism with the refuse container using the actuation mechanism, selectively engaging the refuse container using the refuse container engagement mechanism (step 830). For example, the refuse container engagement mechanism may be configured to transition between the open position and the grasping position. In the grasping position, the refuse container engagement mechanism secures the refuse container between two grabber arms configured to wrap around and grasp the refuse container therebetween.

In some embodiments, after the refuse container engagement mechanism secures the refuse container between the two grabber arms, the method 800 includes initiating actuation of the side-loading lift system (step 835). For example, step 835 may include, upon receiving an indication that the refuse container engagement mechanism has completed securing the refuse container, activating the side-loading lift system such that the refuse container is removed from the ground and the side-loading arm transitions from the extended position towards the refuse dumping position.

After initiating actuation of the side-loading lift system, the method 800 may include transferring refuse material from the refuse container to the hopper at a rear end of the refuse vehicle (step 840). For example, the side-loading lift system may be configured to transition to the refuse-dumping position, at which point the side-loading lift system pauses motion with the refuse container tipped towards the hopper volume such that the refuse material may be dumped into the hopper volume. In some embodiments, step 840 includes dumping the refuse material into the opening of the tailgate at the rear end of the refuse vehicle. In some other embodiments, step 840 includes dumping the refuse material into an intermediate hopper volume, the intermediate hopper volume then configured to transfer the refuse material to a primary refuse compartment through the opening of the tailgate at the rear end of the refuse vehicle.

In some embodiments, the method 800 includes notifying the operator of completion of the refuse collection. For example, a notification may be sent to the operator (e.g., through an interface, a user device, a controls panel, etc.) to indicate the completion. In some embodiments, completion may be marked by the reach arm transitioning from the extended position to the retracted position upon returning the refuse container to the ground. In some other embodiments, completion is marked by the intermediate hopper volume rotating back to a refuse-collecting position (shown in FIGS. 5 and 6) after transferring the refuse material to the primary refuse compartment while in a refuse-dumping position (FIG. 7).

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can include RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present disclosure. Other substitutions, modifications, changes, and omissions may be made in the design, operating conditions, and arrangement of the preferred and other exemplary embodiments without departing from scope of the present disclosure or from the spirit of the appended claim.

What is claimed is:

1. A refuse vehicle comprising:
a chassis;
a body assembly coupled to the chassis and at least partially defining a primary refuse compartment;
a tailgate assembly rotatably coupled to the body assembly at a rear end of the refuse vehicle; and
a lift system coupled to the tailgate assembly, the lift system comprising:
a side-loading arm configured to engage a refuse container and move between a plurality of positions laterally away from the tailgate assembly; and
an actuation mechanism configured to control movement of the side-loading arm.

2. The refuse vehicle of claim 1, wherein the actuation mechanism further comprises:
at least one first actuator configured to selectively extend the side-loading arm laterally away from the chassis between a first position and a second position;
at least one second actuator configured to actuate the side-loading arm to a refuse dumping position;
a sensor configured to generate sensor data indicative of a position of the refuse container; and
a controller configured to:
receive the sensor data indicative of the position of the refuse container from the sensor;
determine the position of the refuse container based on the sensor data; and
initiate the actuation mechanism responsive to the position being within a threshold range of the side-loading arm.

3. The refuse vehicle of claim 2, wherein the first position of the side-loading arm is a retracted position in which the side-loading arm is fully retracted toward the chassis, adjacent the tailgate assembly, and the second position of the side-loading arm is an extended position in which the side-loading arm is extended outwards from the chassis at a greater distance relative to the retracted position.

4. The refuse vehicle of claim 3, wherein in the dumping position the side-loading arm is rotated relative to the retracted position and the extended position.

5. The refuse vehicle of claim 1, wherein the lift system further comprise a refuse container engagement mechanism coupled to the side-loading arm and configured to grasp and release the refuse container.

6. The refuse vehicle of claim 2, wherein the sensor comprises at least one of a camera configured to capture real-time sensor data regarding the position of the refuse container or a position sensor configured to capture real-time sensor data regarding the position of the refuse container.

7. The refuse vehicle of claim 1, wherein the lift system includes a support coupled to the chassis and supporting the side-loading arm.

8. The refuse vehicle of claim 7, wherein the support extends rearward of the body assembly.

9. The refuse vehicle of claim 1, further comprising an intermediate refuse container coupled to at least one of the chassis, the body assembly, or the side-loading arm, the intermediate refuse container configured to receive refuse material from the refuse container via the side-loading arm, the intermediate refuse container movably coupled to the tailgate assembly.

10. The refuse vehicle of claim 9, wherein the intermediate refuse compartment is configured to move laterally away from the tailgate assembly responsive to movement of the side-loading arm.

11. The refuse vehicle of claim 9, wherein the intermediate refuse container is rotatably coupled to the tailgate assembly and is configured to rotate relative to the tailgate assembly to transfer the refuse material from the intermediate refuse container into the primary refuse compartment or to an intermediate hopper defined by the tailgate assembly.

12. The refuse vehicle of claim 9, wherein the lift system includes at least one of (i) a reever having a winch configured to facilitate rotation and dumping of the intermediate refuse container; or (ii) a kick bar assembly configured to facilitate rotation and dumping of the intermediate refuse container.

13. The refuse vehicle of claim 1, wherein the actuation mechanism is further configured to, upon receiving an indication that an operator is manually operating the lift system, operate the lift system based on a plurality of user inputs.

14. The refuse vehicle of claim 1, wherein the actuation mechanism includes a sensor and a controller communicably coupled to the sensor, the controller configured to operate the lift system based on signals received form the sensor.

15. A lift system for a rear loading refuse vehicle, the lift system comprising:
a support configured to mount the lift system to a tailgate assembly of a rear-loading refuse vehicle;
a side-loading arm coupled to the support and configured to move between a plurality of positions;
a refuse container engagement mechanism coupled to the side-loading arm and configured to grasp and release a refuse container;
an actuation mechanism coupled to the side-loading arm and the refuse container engagement mechanism, the actuation mechanism comprising:
at least one first actuator configured to selectively extend the side-loading arm in a direction laterally outwards from the support between a retracted position and an extended position; and
at least one second actuator configured to selectively actuate the refuse container engagement mechanism between an open position and a grasping position.

16. The lift system of claim 15, wherein the actuation mechanism further comprises:
a sensor configured to generate sensor data indicative of a position of the refuse container; and
a controller configured to:
receive the sensor data indicative of the position of the refuse container from the sensor;
determine the position of the refuse container based on the sensor data; and
initiate the actuation mechanism responsive to the position being within a threshold range of the side-loading arm.

17. The lift system of claim 15, further comprising an intermediate refuse container coupled to the support and configured to receive refuse material deposited from the refuse container by the side-loading arm.

18. A method for operating a lift system of a rear loading refuse vehicle, the method comprising:
activating an actuation mechanism to reposition a side-loading arm of the refuse vehicle laterally outward from a tailgate assembly of the refuse vehicle;
engaging a refuse container using the side-loading arm; and
controlling the actuation mechanism to transfer refuse material from the refuse container to a hopper of a refuse vehicle that is defined by the tailgate assembly.

19. The method of claim 18, further comprising:
obtaining, by a controller, sensor data regarding a position of the refuse container relative to the side-loading arm;
determining a location of the refuse container based on the sensor data; and
controlling, by the controller, movement of the refuse vehicle to align a refuse container engagement mechanism with the refuse container based on the location of the refuse container.

20. The method of claim 19, further comprising actuating, by the actuation mechanism, the side-loading arm responsive to the location being within a threshold range of the side-loading arm.
